(19) United States
(12) Patent Application Publication
(10) Pub. No.: US 2005/0158461 A1
(43) Pub. Date: Jul. 21, 2005

(54) Methods of making reflective elements

(75) Inventors: Terrance L. Bescup, River Falls, WI (US); Stephen L. Lieder, Wyoming, MN (US); Joseph D. Engebretson, Cottage Grove, MN (US); Dale H. Haunschild, Hudson, WI (US); Michael C. Martin, Hudson, WI (US); Steven J. Lenius, Woodbury, MN (US); Soemantri Widagdo, St. Paul, MN (US); Glen A. Jerry, Roseville, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/761,874

(22) Filed: Jan. 21, 2004

(51) Int. Cl. B05D 5/06

(52) U.S. Cl. 427/163.4

(57) ABSTRACT

The invention generally relates to methods of embedding secondary particles onto the surface of a primary particle by means of a polymeric material and in particular to methods of making retroreflective elements.

### FIELD OF THE INVENTION

The invention generally relates to methods of embedding secondary particles onto the surface of a primary particle by means of a polymeric material, and in particular to methods of making retroreflective elements.

### BACKGROUND OF THE INVENTION

The use of pavement markings (e.g. paints, tapes, and individually mounted articles) to guide and direct motorists traveling along a roadway is well known. During the daytime the markings may be sufficiently visible under ambient light to effectively signal and guide a motorist. At night, however, especially when the primary source of illumination is the motorist's vehicle headlights, the markings are generally insufficient to adequately guide a motorist because the light from the headlight hits the pavement and marking at a very low angle of incidence and is largely reflected away from the motorist. For this reason, improved pavement markings with retroreflective properties have been employed.

Retroreflection describes the mechanism where light incident on a surface is reflected so that much of the incident beam is directed back towards its source. The most common retroreflective pavement markings, such as lane lines on roadways, are made by dropping transparent glass or ceramic optical elements onto a freshly painted line such that the optical elements become partially embedded therein. The transparent optical elements each act as a spherical lens and thus, the incident light passes through the optical elements to the base paint or sheet striking pigment particles therein. The pigment particles scatter the light redirecting a portion of the light back into the optical element such that a portion is then redirected back towards the light source.

Vertical surfaces tend to provide better orientation for retroreflection. Therefore, numerous approaches have been made to incorporate vertical surfaces in pavement markings, typically by providing protrusions in the marking surface. Vertical surfaces can prevent the build-up of a layer of water over the retroreflective surface during rainy weather that may otherwise interfere with the retroreflection mechanism of optical elements exposed on the surface.

In order to increase the number of optical elements that are provided in a vertical orientation, reflective elements have been developed wherein optical elements are bonded to a core particle. See for example, U.S. Pat. No. 3,175,935 (Vanstrum); U.S. Pat. No. 3,043,196 (Palmquist); and U.S. Pat. No. 3,252,376 (De Vries).

As yet another example, U.S. Pat. Nos. 5,772,265 and 5,942,280 describe all-ceramic retroreflective elements that may be used in pavement markings comprising an opacified ceramic core and ceramic optical elements partially embedded into the core (abstract). Representative retroreflective elements of this nature are commercially available from 3M Company, St. Paul, Minn. under the trade designations “3M Stamark™ Liquid Pavement Markings Elements 1270” (white) and “3M Stamark™ Liquid Pavement Markings Elements 1271” (yellow). Such retroreflective elements have been employed in pavement markings.

Although such retroreflective elements provide suitable retroreflective properties in combination with suitable durability, industry would find advantage in alternative methods of making retroreflective elements, particularly methods amenable to the manufacture of retroreflective elements at a reduced cost.

### SUMMARY OF THE INVENTION

The invention discloses methods of making retroreflective elements comprising providing a plurality of core particles, coating the particles with an unsolidified polymeric composition forming coated particles, combining the coated particles with optical elements such that optical elements are embedded in the unsolidified polymeric composition, and solidifying the polymeric composition forming retroreflective elements.

In one embodiment, the method comprises combining the coated particles with the optical elements in a continuous process. The core particles and/or and/or polymeric composition and/or optical elements may be continuously provided as well.

In another embodiment, the method comprises providing a plurality of core particles having surfaces comprising an unsolidified polymeric composition; combining the core particles with optical elements by means of a device comprising at least one rotating mixing member selected from the group consisting of a disc, an extruder screw, co-rotating or counter-rotating blades, and grinding plates, such that optical elements are embedded in the unsolidified polymeric composition; and solidifying the polymeric composition forming retroreflective elements.

In each of these embodiments, the unsolidified polymeric composition may be a molten thermoplastic resin or a bonded resin core precursor. An excess of optical elements are preferably provided, the method further comprising separating the retroreflective elements from the unembedded optical elements. The core particles typically range in size from about 0.1 mm to about 3 mm. Further, the core particles may consist of an inorganic material such as sand, roofing granules, and skid particles. Transparent microcrystalline beads are preferably employed in combination with a polymeric composition comprising at least one light scattering material. Various types of optical elements may concurrently be provided. In one aspect, the provided optical elements include first optical elements having a refractive index ranging from about 1.5 to about 2.0 and second optical elements have a refractive index ranging from about 1.7 to about 2.4.

The methods described herein may be amenable to the formation of other types of articles wherein (e.g. smaller) secondary particles are embedded on the surface of a core particle by means of a polymeric composition.

### BRIEF DESCRIPTION OF THE DRAWING

FIG. 1 depicts a schematic diagram of an exemplary continuous method for embedding small particles onto the surface of a larger particle suitable for making retroreflective elements.

FIG. 2 depicts enlarged cross-sectional views of the core particles, coated particles, and retroreflection elements of the invention.

### DETAILED DESCRIPTION OF THE INVENTION

The invention generally relates to methods of embedding secondary particles onto the surface of a primary particle by means of a polymeric material and in particular to methods of making retroreflective elements. In the methods of making retroreflective elements optical elements are partially embedded into the surface of core particle comprising an unsolidified polymeric composition.

The primary particle is referred to herein as the “core particle” since it is the innermost part relative to the embedded secondary particles. The core particle typically comprises a single particle ranging in size from about 0.1 mm to about 10 mm. Preferably, the particle size is greater than 300 microns and less than 2000 microns. The core particle is typically comprised of an inorganic material. The presence of the interior inorganic particle is surmised to aid in the prevention of deformation of the particle during the process of embedding the smaller particles (e.g. optical elements). Suitable inorganic particles include sand, roofing granules and skid particles such as those commonly used in pavement markings.

In preferred embodiments, the core particle is coated with an unsolidified polymeric composition. The unsolidified polymeric composition is preferably a “bonded resin core precursor” which refers to a crosslinkable polymeric resin. The bonded resin core precursor composition comprises monomeric, oligomeric, and/or polymeric components, and mixtures thereof, that crosslink upon exposure to heat (e.g. thermoset), actinic radiation (e.g. ultraviolet light, electron beam) or other chemical reaction (e.g. catalyst). It is surmised, however, that the unsolidified polymeric material may alternatively comprise a molten thermoplastic resin. By “molten” it is meant that the thermoplastic resin is substantially softened such that secondary particles (e.g. optical elements) can be embedded therein.

For the presently preferred core particle dimensions for retroreflective elements, having a diameter ranging from about 0.2 (i.e. 200 microns) to about 10 millimeters, the optical elements typically range in size from about 30 to about 300 micrometers in diameter. In preferred embodiments, the secondary particles of the retroreflective element are smaller than the core particle. Typically, the secondary particles are less than one half of the diameter of the core particle. In preferred embodiments, the secondary particles (e.g. optical elements) are 100 to 300 times smaller than the core particle, resulting in a plurality of (e.g. optical elements) secondary particles embedded on the surface of the core particle. In alternative interstitial embodiments, the secondary particles may be larger than the primary particle, resulting in for example four secondary particles closely packed about the core particle. The secondary particles may be of any size between the previously stated dimensions as well.

As used herein, “optical elements” refers to granules, flakes, fibers, beads etc. that reflect light either independently or when combined with a diffusely reflecting core.

Spheroidal transparent elements, also described herein as “beads”, “glass beads” and “glass-ceramic beads” are typically preferred. Typically, the optical elements have a refractive index of about 1.5 to about 2.6. The optical elements are comprised of inorganic materials that are not readily susceptible to abrasion. The optical elements (e.g. transparent beads) may comprise an amorphous phase, a crystalline phase, or a combination thereof.

The optical elements most widely used in pavement markings are made of soda-lime-silicate glasses. Although the durability is acceptable, the refractive index is only about 1.5, which greatly limits their retroreflective brightness. Higher-index glass optical elements of improved durability that can be used herein are taught in U.S. Pat. No. 4,367,919.

For increased crush strength, the beads are preferably microcrystalline. Representative microcrystalline beads may be non-vitreous, such as described in U.S. Pat. No. 4,564,556 (Lange), incorporated herein by reference or the beads may comprise a glass-ceramic material, such as described in U.S. Pat. No. 6,461,988, also incorporated herein by reference. Microcrystalline optical elements are also described in U.S. Pat. Nos. 4,758,469 and 6,245,700; incorporated herein by reference. The optical elements preferably are resistant to scratching and chipping, are relatively hard (above 700 Knoop hardness), and are made to have a relatively high index of refraction.

The secondary particles (e.g. optical elements) are typically embedded to a depth sufficient to hold the particles in the core during processing and use. Embedment of at least 20% of the diameter, particularly in the case of spheriodal optical elements (e.g. microcrystalline beads), typically will effectively hold the optical element into the core. By 20% embedded, it is meant that about 80% of the total number of optical elements are embedded within the core surface such that about 20% of each bead is sunk into the core and about 80% is exposed on the core surface. If the optical elements are embedded greater than about 80%, the retroreflective properties tend to be substantially diminished. In order to obtain a balance of bonding between the optical elements and the core in combination with suitable retroreflectivity, typically more than about 90% of the total number of beads are embedded to a depth of about 40% to about 60%.

Although the methods of the invention are described herein in with reference to methods of making retroreflective elements, these same methods may also be suitable for other articles wherein secondary particles are bonded to a core particle by means of an unsolidified polymeric material.

In one aspect, the method of making retroreflective elements comprises providing a plurality of (e.g. inorganic) core particles, coating the particles with an unsolidified polymeric composition such as a bonded resin precursor, combining the coated particles with optical elements in a continuous process such that optical elements are embedded in the unsolidified polymeric composition, and solidifying the polymeric composition forming retroreflective elements.

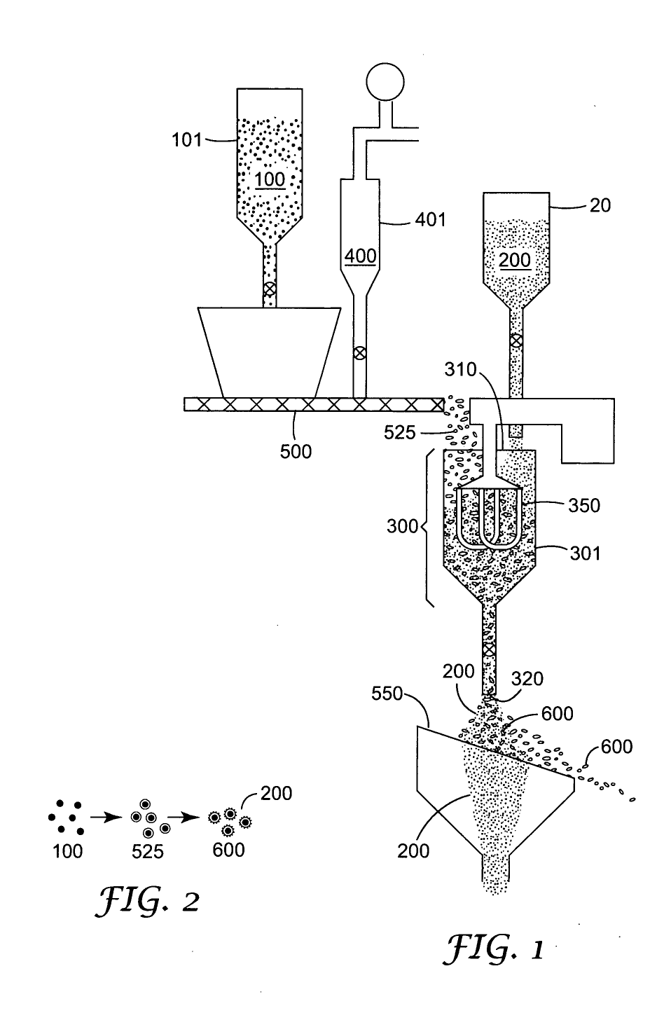

With reference to FIG. 1 depicting an exemplary continuous process, core (e.g. sand) particles 100 and optical elements 200 (e.g. glass-ceramic beads) are continuously provided to a mixing station 300. The core and secondary particles (e.g. optical elements) may be provided in any manner, such as by means of a first 101 and second 201 gravity fed hopper. Alternatively, the core and secondary particle may be metered to the mixing station. Various mass and volumetric metering devices are known. Representative suitable metering devices include screw conveyors and feeders such as can be found on the internet website www.ajax.co.uk.

An unsolidified polymeric composition 400 is coated onto the core particles. The polymeric composition may be contained in a vessel 401 that is pumped to the mixing station. Preferably, the unsolidified polymeric composition is metered as well. Provided that the unsolidified polymeric composition is sufficiently low in viscosity, the composition may alternatively be gravity fed to the mixing station. For embodiments, wherein the unsolidified polymer composition is a molten thermoplastic resin, the resin may be premelted or the containment vessel may be equipped with heater to melt the resin.

The rate at which the core particles and unsolidified polymeric composition is provided can vary depending on the particle size of the core particle as well as the desired thickness of the unsolidified polymeric composition on the core particle. In a preferred embodiment, the ratio of the rate of delivery of unsolidified polymeric composition to (e.g. inorganic) core particle is about 1 to 10 by weight (e.g. for core particles of a 20/30 mesh size).

The unsolidified polymeric composition is coated onto the core particles at a coating station 500 equipped with a suitable mixing means. Typically, the unsolidified polymeric composition is relatively low in viscosity and thus can easily be coated onto the surface of the core particles. For example, the core material and unsolidified polymeric composition can both be metered at the weight ratios just described into a continuous mixer such as commercially available from Ajax Equipment Limited, UK under the trade designation “Ajax LynFlow Continuous Mixer”. Such mixer is equipped with a pair of screw conveyors. When the appropriate amount of unsolidified polymeric composition is provided, there is typically no need to separate excess unsolidified polymeric composition from the exiting coated particles 525. Alternatively, yet less convenient the core particle may be coated with an excess of bonded resin precursor and the uncoated material separated from the coated particle. This can be accomplished for example by conveying the mixture over a screen having an appropriately smaller mesh than the core particles so as only to allow passage of the excess unsolidified polymeric material. Other suitable means for coating the core particles with an unsolidified polymeric composition includes disc coaters such as described in U.S. Pat. Nos. 5,447,565; 4,675,140; and 5,061,520; as well as grinding and extruders, as will subsequently be described, and the like.

The unsolidified polymeric material may optionally comprise other ingredients such as fillers (e.g. glass beads) and solvents(s). When present, these other ingredients can be combined prior to (e.g. continuously) or concurrently with coating the core particle. In one suitable method, a light scattering material (e.g. pearlescent pigment) is combined with a bonded resin core precursor by means of a small secondary extruder.

Regardless however, the polymeric composition, prior to solidifying (e.g. curing), has a suitable viscosity to coat the core particles. It has been found that the Brookfield viscosity of a bonded resin precursor composition at 72° F., prior to curing and prior to addition of light scattering material typically has a viscosity of at least about 1000 cps. In order to disperse relatively high concentrations of light scattering material, however, the Brookfield viscosity of the bonded resin composition at 72° F. is typically less than 10,000 cps (e.g. less than 9,000 cps; 8,000 cps, 7,000 cps; 6,000 cps; 5,000 cps). For example, the bonded resin precursor may have a Brookfield viscosity at 72° F. of about 1500 cps to 2500 cps.

The coated core particles are combined with the secondary particles (e.g. optical elements). In preferred embodiments, these materials are combined in a continuous process. As used herein continuous process refers to a non-batch process. This is typically accomplished by the mixing station 300 having an entrance 310 for receipt of the coated particles at a different location than the exit 320 for the particle embedded with the secondary particles (e.g. optical elements). Typically, the entrance and exit of the mixing station are located at opposing ends. For example, for gravity fed methods, the entrance is positioned above the mixer and the exit positioned below. However, the entire apparatus or portions thereof may be configured in a horizontal rather than vertical configuration as is often the case when an extruder is employed.

The ratio of the rate of delivery of the secondary (e.g. optical element) to the rate of delivery of the coated core particle can vary depending on the particle sizes. The ratio of the rate of delivery of the secondary (e.g. optical element) particles to the rate of delivery of the coated core particles generally ranges from 0.2:1 to 10:1. (e.g. for core particles of a 20/30 mesh size). It is generally preferred to provide an excess of secondary (e.g. optical element) particles (i.e. even 20:1). The un-embedded secondary particles 200 may then be separated from the retroreflective elements for example by a screen 550 and recycled if desired.

The mixing station is equipped with a suitable mechanical mixing means. The Applicant has found mechanical mixing advantageous in preventing the undesirable formation of agglomerations, i.e. the bonding of more than one core particle to each other. In preferred methods, retroreflective elements are formed that comprise a single core embedded with optical elements by means of the polymeric coating. During the continuous method described herein, coated core particles and optical elements are preferably continuously fed into the mixing station. Further, the mixing station preferably continuously forms retroreflective elements by embedding the optical elements on the surface of the coated particles. Retroreflective elements 600 preferably continuously exit from the mixing station as well.

As used herein, mechanical mixing refers to a device having at least one rotating mixing member. With the exception of the disc coater, the mixing device preferably comprises a pair of co-rotating or counter-rotating blades. Preferably, the surface area (cm²) of the mixing blades relative to the volume (ml) of material being mixed is about 1:7. The mixing device forces the coated core particles and secondary particles through at least one high shear field. Preferably the “dead space” is minimized, by radius of the mixing blade(s) positioned such that it closely approaches (e.g. within about 0.5 mm) the inner peripheral surface of the vessel 301 in order that unmixed material does not accumulate on the vessel wall. Alternatively, but typically less efficient the vessel can be equipped with one or more blade that scrape the vessel wall.

Various mechanical mixing devices having at least one rotating mixing member have been determined to be suitable by the Applicant. The rotational speed of the mixing member(s) can vary depending on the equipment used.

One suitable mixing device, as depicted in FIG. 1 comprises at least one pair of co-rotating or counter-rotating mixing blades 350. Any number of individual mixing blades may be present. The suitability of such a mixing device has been exemplified herein by use of a hand mixer having four blades on each of two “beaters”. It is apparent to one of ordinary skill in the art that this mixing configuration can be scaled up to an industrial capacity. The co-rotation of the mixing blades forces the coated core particles and the optical elements to pass between the pair of blades. Typically this is done at high speeds in order to provide sufficient force for proper embedment as well as the breaking apart of any agglomerations that may form. In one embodiment, the rotational speed is typically at least about 1000 revolutions per minute (“rpm”), and more typically at least about 2000 rpm (e.g. 2500), ranging up to about 4000 rpm.

Another suitable mixing device comprising a rotating mixing element is a grinding mill that includes at least one rotating grinding plate. Grinding mills are also referred to as burr mills, disk mills, and attrition mills. Grinding mill machines typically include two metal plates having small projections (i.e. burrs). Alternatively, abrasive stones may be employed as the grinding plates. One plate may be stationary while the other rotates, or both may rotate in opposite directions. In one embodiment, the rotational speed is about 80 rpm revolutions per minute. Grinding takes place between the plates that may operate in a vertical or horizontal plane. For vertical arrangements, the coated core particles and secondary (e.g. optical element) particles would typically enter above the plates and retoreflective elements 600 emerge from the bottom, as depicted in FIG. 1. The distance (i.e. gap) between the plates is adjustable. In the present invention, the gap is set such that it is larger than the dimension of the largest particle employed (e.g. core particle), yet smaller in dimension that an agglomeration comprising two or more core particles bonded to each other. By setting the gap in this manner, agglomerations are too large to pass through the gap and thus cannot emerge until broken up by the grinding plates. Various industrial grinding mills are commercially available, such as can be found at the internet web site www.aaoofoods.com/graingrinders.

A third suitable mixing device comprising at least one rotating mixing member is an extruder. Extruders generally include at least one screw within a cylindrical housing. Material is mixed during its course of travel though the helical channels defined by the flights of the screw(s). Extruders generally range in dimension from 10 L/D (i.e. length to diameter) to 60 L/D.

Preferably, a twin-screw extruder is employed having co-rotating or counter-rotating screws including thosereferred to as intermeshing extruders. One suitable twin-screw extruder is commercially available from Baker Perkins, Saginaw, Mich. under the trade designation “Baker Perkins MPCNV-50 Continuous Mixer”. The rotational speed for this extruder typically ranges from about 25 to 225 revolutions per minute. A suitable setup for this extruder in order from the beginning of the extruder to the exit of the extruder includes: (1) 5 inches (12.7 cm) of forward conveying flights, (2) 1.5 inches (3.8 cm) of reverse gear mixers 1050-3LDE-FFR/1.50-8, (3) 3 inches (7.6 cm) of forward conveying flights, (4) 3 inches (7.6 cm) of forward gear mixers 1050-3LDE-RFL/1.50-8, and (5) 8 inches (20.3 cm) of forward conveying flights. Suitable feed locations of the binder, sand, and optical elements relative to the beginning of the extruder with their proximity to the screw assembly can be for example (1) sand addition at 3.5 inches (8.9 cm) with the bonded resin precursor through the same port at 4 inches (10.2 cm), (2) optical elements addition at 10 inches (25.4 cm) (over the forward gear mixer assembly) and (3) retroreflective elements exiting at 20 inches (50.8 cm). The feed location of the optical elements can be within 10 inches (25.4 cm) or less from the exit of the extruder. Further, the location of the start of the forward gear mixer can be adjusted accordingly to match the feed location.

Other suitable twin-screw extruders are commercially available from various suppliers including for example Berstorff (Florence, Ky.), Coperion (Ramsey, N.J.), JSW (Corona, Calif.) and Leistritz (Somerville, N.J.). If desired, extruders having more than two screws can be employed, e.g., three or four screw extruders. As will be appreciated by those skilled in the art, the screw configuration and extruder operating conditions can be optimization or adjusted depending on the materials and equipment employed. Representative extruders and extruder screws are shown in U.S. Pat. Nos. 4,875,847, 4,900,156, 4,911,558, 5,267,788, 5,499,870, 5,593,227, 5,597,235, 5,628,560 and 5,873,654.

Single-screw extruders may also be suitable. Typically, single screw extruders differ from screw feeders and conveyors by either the speed in which they are run (i.e. rpm of the screw) and/or the surface area of the blades relative to the volume being mixed. In view of these differences, screw feeders and conveyors are typically not capable of mixing and pumping polymeric materials nor melting polymeric material when desired. One type of single-screw extruder is commercially available from Coperion Buss Kneader MKS, Ramsey, N.J. under the trade designation “Modular Kneader System”. This device has a single reciprocating screw. The screw has three screw flights and rotates/oscillates in the mixing chamber. The chamber is lined with pins or teeth. Other single screw extruders are commercially available from Crompton, Pawcatuck, Conn. and Meritt-Davis, Hamden, Conn.

Each of the mechanical mixing means just described preferably comprise at least one pair of co-rotating or counter-rotating mixing elements (i.e. blades, screws, grinding plates). Another suitable mixing device comprises a single rotating disc. Representative devices including rotating disc coating apparatus as described in U.S. Pat. Nos. 5,447,565; 4,675,140; and 5,061,520. These patents, however, are concerned with the coating of solid particles with a liquid coating. The Applicant has found that a rotating disc coater is also suitable for embedding solid particles onto a coated core particle. A preferred rotating disc coater for this purpose is described in Attorney Docket No. 59504US002 entitled “DISC COATER”; filed on the same day as the present application, incorporated herein by reference. The coater concludes a disc having a periphery, a motor engaging the disc so as to be able to spin the disc, and a restrictor mounted adjacent to the disc so as to provide a gap for the egress of coated particles near the periphery of the disc. The restrictor may include a flange portion positioned above the disc so that the gap between the restrictor and the disc extends over a significant portion of the disc's radius. Further, the restrictor may also have a portion adjacent to the flange portion (e.g. frusto-conical shape) so that the height of the space between the disc and the restrictor diminishes with radial distance from the center of the disc. This is surmised to meter the particles evenly into the gap. Typically, the gap is set to a height only slightly larger than the maximum theoretical size of one of the sand particles having a single layer of the retroreflective beads. The rotational speed of this device typically ranges from 300 revolutions per minute to 700 revolutions per minute.

The rate of output of retroreflective elements of the (e.g. continuous) method of the invention is preferably at least 20 lbs./hour, more preferably at least 50 lbs./hour, more preferably at least 100 lbs./hour, and even more preferably at least 150 lbs./hours and greater. Substantially higher outputs could be achieved for example by use of a larger extruder of other means as would readily be apparent to one of ordinary skill in the art.

Various polymeric materials may be employed to coat the core particle including various one and two-part curable binders, as well as thermoplastic binders wherein the binder attains a liquid state via heating until molten. Common binder materials include polyacrylates, methacrylates, polyolefins, polyurethanes, polyepoxide resins, phenolic resins, and polyesters. Preferred polymeric materials in view of their known durability include those materials that have been employed as a binder in the making of pavement markings. As one example, a two-part composition having an amine component including one or more aliphatic (e.g. aspartic ester) amines and optionally one or more amine-functional coreactants, an isocyanate component including one or more polyisocyanates, and material selected from the group of fillers, extenders, pigments and combinations thereof may be employed such as compositions described in U.S. Pat. No. 6,166,106, incorporated herein by reference. As another example, a suitable epoxy resin may be obtained from 3M Company, St. Paul, Minn. under the trade designation “3M Scotchcast Electrical Resin Product No. 5″

Preferred bonded resins include certain polyurethanes including those derived from the reaction product of a trifunctional polyol, such as commercially available from Dow Chemical, Danbury, Conn. under the trade designation “Tone 0301”, with an adduct of hexamethylene diisocyanate (HDI), such as commercially available from Bayer Corp., Pittsburg, Pa. under the trade designation “Desmodur N-100” at a weight ratio of about 1:2. The physical properties of bonded resins, and in particular the bonded resins specifically described and exemplified herein, can be further characterized according to various known techniques to determine the glass transition temperature (Tg), tensile strength, elastic modulus etc., as such physical properties are inherent properties of the bonded resin compositions described herein. It is appreciated that other bonded resin compositions having similar physical properties may contribute comparable results.

Other polyester polyols that may be employed at appropriate equivalent weights include “Tone 0305”, “Tone 0310” and “Tone 0210”. Further, other polyisocyanates include “Desmodur N-3200”, “Desmodur N-3300”, “Desmodur N-3400”, “Desmodur N-3600”, as well as “Desmodur BL 3175A”, a blocked polyisocyanate based on HDI, that is surmised to contribute substantially improved “pot life” as a result of minimal changes in viscosity of the polyol/polyisocyanate mixture.

Non-diffusely reflecting coated core particle (e.g. transparent core) may be employed in combination with specularly reflecting optical elements, such as would be provided by the glass beads described in U.S. Pat. Nos. 3,274,888 and 3,486,952. In preferred embodiments, however, the coat core particle comprises at least one light scattering material dispersed within the polymeric coating. Accordingly, the optical elements are typically transparent and substantially free of specular reflecting properties (e.g., free of metals).

The reflection of the core material comprising one or more light scattering materials can conveniently be characterized as described in ANSI Standard PH2.17-1985. The value measured is the reflectance factor that compares the diffuse reflection from a sample, at specific angles, to that from a standard calibrated to a perfect diffuse reflecting material. For retroreflective elements that employ a diffusely reflecting core, the reflectance factor of the core is typically at least 75% at a thickness of 500 micrometers for retroreflective elements with adequate brightness for highway markings. More typically, the core has a reflectance factor of at least 85% at a thickness of 500 micrometers.

Diffuse reflection is caused by light scattering within the material. The degree of light scattering is generally due to a difference in the refractive index of the scattering phase in comparison to the base composition of the core phase. An increase in light scattering is observed typically when the difference in refractive index is greater than about 0.1. Typically, the refractive index difference is greater than about 0.4. (e.g. greater than 0.5, 0.6, 0.7 and 0.8).

Light scattering can be provided by combining the unsolidified polymeric composition with at least one diffusely reflecting particles and/or at least one specularly reflecting particles (e.g. aluminum flake, pearlescent pigment). Examples of useful diffuse pigments include, but are not limited to, titanium dioxide, zinc oxide, zinc sulfide, lithophone, zirconium silicate, zirconium oxide, natural and synthetic barium sulfates, and combinations thereof. An example of a useful specular pigment is a pearlescent pigment, such as pearlescent pigments commercially available from EM Industries, Inc., Hawthorne, N.Y. under the trade designations “Afflair 9103” and “Afflair 9119” and commercially available from The EM Industries of Hawthorne, N.Y. under the trade designations “Mearlin Fine Pearl #139V” and “Bright Silver #139Z”. The diffusely reflective pigments are typically employed at a concentration of at least 30 wt-%. Specularly reflecting pigments are preferred and typically employed in an amount of at least 10 wt-% (e.g. 15 wt-%, 20 wt-% and any amounts therebetween). Other pigments may be added to the core material to produce a colored retroreflective element. In particular yellow, is a desirable color for pavement markings. In order to maximize the reflectance of the element, particularly in combination with transparent microspheres, it is preferred to maximize the concentration of pigment provided that coating viscosity, and cured binder physical properties are not compromised. Typically, the maximum total amount of light scattering material is about 40 to 45 wt-%.

Typically, for optimal retroreflective effect, the optical elements have a refractive index ranging from about 1.5 to about 2.0 for optimal dry retroreflectivity, preferably ranging from about 1.5 to about 1.9. For optimal wet retroreflectivity, the optical elements have a refractive index ranging from about 1.7 to about 2.4, preferably ranging from about 1.9 to 2.4, and more preferably ranging from about 2.1 to about 2.3.

Different types of optical elements having the same, or approximately the same refractive index may be employed. The optical elements may have two or more refractive indices. Typically, optical elements having a higher refractive index perform better when wet and optical elements having a lower refractive index perform better when dry. When a blend of optical elements having different refractive indices is used, the ratio of the higher refractive index optical elements to the lower refractive index optical elements is preferably about 1.05 to about 1.4, and more preferably from about 1.08 to about 1.3.

The optical elements can be colored to retroreflect a variety of colors such as color matched to the pavement marking binders (e.g. paints) in which they are to be embedded. Techniques to prepare colored ceramic optical elements that can be used herein are described in U.S. Pat. No. 4,564,556. Colorants such as ferric nitrate (for red or orange) may be added in the amount of about 1 to about 5 weight percent of the total metal oxide present. Color may also be imparted by the interaction of two colorless compounds under certain processing conditions (e.g., TiO₂ and ZrO₂ may interact to produce a yellow color).

Regardless of the method, the optical elements (e.g. beads) are preferably treated with at least one adhesion promoting agent and/or at least one floatation agent. Further, the (e.g. inorganic) core particle may be treated with an adhesion promoting agent as well.

Adhesion promoting agents, also referred to as coupling agents, typically comprise at least one functional group that interacts with the polymeric composition and a second functional group that interacts with the optical element and/or core. In general, the adhesion promoting agent is chosen based on the chemistry of the polymeric composition. For example, vinyl terminated adhesion promoting agents are preferred for polyester-based bonded resins, such as polyester resins formed from addition reactions. In the case of epoxy bonded resins, amine terminated adhesion promoting agents are preferred. A preferred adhesion promoting agents for polyurethanes, particularly for microcrystalline optical elements (e.g. glass-ceramic beads) and inorganic core materials (e.g. sand, skid particles) are amine terminated silanes such as 3-aminopropyltriethoxysilane, commercially available from OSI Specialties, Danbury, Conn. under the trade designation “Silquest A-1100”.

Suitable floatation agents include various fluorochemicals such as described in U.S. Pat. No. 3,222,204, U.S. Pat. Publication No. 02-0090515-A1, and U.S. Pat. Publication No. 03-0091794-A1, each of which are incorporated herein by reference. A preferred floatation agent includes polyfluoropolyether based surface treatment such as poly(hexafluoropropylene oxide) having a carboxylic acid group located on one chain terminus, commercially available from Du Pont, Wilmington, Del. under the trade designation “Krytox”. “Krytox” 157 FS is available in three relatively broad molecular weight ranges, 2500 g/mole (FSL), 3500-4000 g/mole (FSM) and 7000-7500 g/mole (FSH), respectively for the low, medium and high molecular weights. The low and medium molecular weight grades are preferred for aqueous delivery of the surface treatment. Other preferred floatation agents are described in WO 01/30873 (e.g. Example 16).

For use in pavement markings, the retroreflective elements may have virtually any size and shape, provided that the coefficient of retroreflection (R_{A}), is at least about 3 cd/lux/m² according to Procedure B of ASTM Standard E809-94a using an entrance angle of −4.0 degrees and an observation angle of 0.2 degrees. The preferred size of the retroreflective elements, particularly for pavement marking uses, ranges from about 0.2 mm to about 10 mm and is more preferably about 0.5 mm to about 3 mm. Further, substantially spherical elements are more preferred. For the majority of pavement marking uses, R_{A} is typically at least about 5 cd/lux/m² (e.g. at least 6 cd/lux/m², at least 7 cd/lux/m², at least 8 cd/lux/m² and greater).

The methods described herein result in retroreflective elements having at least comparable and often better retroreflective properties in comparison to retroreflective elements having a ceramic core, yet can be manufactured at a substantially lower cost due to the invention described herein. Thus, pavement markings comprising retroreflective elements prepared from the method of the invention will exhibit at least the same, and often better initial retroreflectivity when measured according to ASTM E 1710-97. It is also surmised that the resulting retroreflective elements may exhibit comparable durability in comparison to retroreflective elements having a ceramic core. “The same retroreflective elements” refers to retroeflective elements comprising the same optical elements with the primary difference being that the core comprises a different composition.

The initial Coefficient of Retroreflected Luminance (R_{L}) of the pavement markings of the invention is at least 1000 candelas/m²/lux and thus at least about the same initial R_{L} as the same reflective element having an opacified ceramic core. In preferred embodiments, the pavement markings of the invention exhibit improved retroreflective properties. For such embodiments, the initial R_{L} may be at least 1400 candelas/m²′lux, at least 1600 candelas/m²/lux, at least 1800 candelas/m²/lux, and about 2000 candelas/m²/lux or greater. By employing retroreflective elements having a higher initial coefficient of retroreflected luminance, the coefficient of retroreflected luminance after wear testing is also higher, as the rate of loss of retroreflected luminance may be about the same. Accordingly, pavement markings employing elements having a higher initial R_{L} advantageously are more durable in that such marking exhibits a minimum R_{L} of at least 200 candelas/m²/lux for a longer duration of time, (i.e. 1 year, 2 years, 3 years, greater than 5 years, and intervals of time there between depending on the environmental conditions).

The retroreflective elements of the invention prepared from the methods described herein can be employed for producing a variety of retroreflective products or articles such as retroreflective sheeting and in particular pavement markings. Such products share the common feature of comprising a binder layer and a multitude of retroreflective elements embedded at least partially into the binder surface such that at least a portion of the retroreflective elements are exposed on the surface. In the retroreflective article of the invention, at least a portion of the retroreflective elements will comprise the retroeflective elements of the invention and thus, the inventive elements may be used in combination with other retroreflective elements as well as with other optical elements (e.g. transparent beads).

Objects and advantages of the invention are further illustrated by the following examples, but the particular materials and amounts thereof recited in the examples, as well as other conditions and details, should not be construed to unduly limit the invention. All percentages and ratios herein are by weight unless otherwise specified.

### EXAMPLES

Test Methods

Retroreflection of Reflective Elements—Coefficient of Retroreflection (R_{A})

Brightness was measured as the coefficient of retroreflection (R_{A}) by placing enough retroeflective elements in the bottom of a dish that was at least 2.86 cm in diameter such that no part of the bottom of the dish was visible. Then Procedure B of ASTM Standard E809-94a was followed, using an entrance angle of −4.0 degrees and an observation angle of 0.2 degrees. The photometer used for the measurements is described in U.S. Defensive Publication No. T987,003.

Optical Elements

The optical elements employed in the Examples were glass ceramic beads having a starting oxide material composition by weight of 30.9% TiO₂, 15.8% SiO₂, 14.5% ZrO₂, 1.7% MgO, 25.4% Al₂O₃ and 11.7% CaO. The beads were prepared according to U.S. Pat. No. 6,245,700 to provide beads that had a nominal refractive index of 1.9. The beads were surface treated first with “Silquest A-1100” adhesion promoting agent by first diluting approximately 8 wt-% of “Silquest A-1100” with water such that the amount was sufficient to coat the beads and provide 600 ppm on the dried beads. The beads were then treated with “Krytox 157 FSL” floatation promoting agent in the same manner, to provide 100 ppm of such treatment. Each surface treatment was applied by placing the beads in a stainless steel bowl and drizzling the diluted solution of the surface treatment over the beads while continuously mixing to provide wetting of each bead. After each treatment, the optical elements were placed in an aluminum drying tray at a thickness of about 1.9 cm and dried in a 66° C. oven for approximately 30 minutes.

Bonded Resin Core Precursor

A polyurethane precursor composition was prepared by hand mixing the following ingredients to form a binder:

| Wt. % | |
|---|---|
| 15.3% | Polyester polyol, available from Dow Chemical, |
| | Danbury, CT under the trade designation “TONE |
| | 0301” (Brookfield viscosity = 2400 at 72° F.) |
| 31% | Aliphatic polyisocyanate, available from Bayer |
| | Corp., Pittsburgh, PA under the trade designation |
| | “DESMODUR N-100” (Brookfield viscosity = 7500 |
| | at 72° F.) |
| 37% | pearlescent pigment, commercially available from EM Industries |
| | Corporation under the trade designation “AFFLAIR 9119” |
| 5.9% | methyl ethyl ketone solvent |
| 5.9% | acetone solvent |
| 4.9% | additives (dispersants, modifiers) |

Inorganic Core Particle

Sandblast type sand in the 20/30 mesh range (840/600 microns) commercially available from Badger Mining, Berlin, Wis. under the trade designation “BB2” was employed.

### Example 1

### Co-Rotating Blade Mixer Method

The sand was surface treated with 600 ppm “Silquest A1100” (without “Krytox 157 FSL”) in the same manner as previously described for surface treating the beads. One part of the bonded resin core precursor was added to 10 parts of treated sand. The sand and binder were mixed by hand with a spatula until all of the sand was thoroughly coated with binder. The retroreflective elements were prepared by mixing 40 g of coated sand and 1200 g of optical elements in a 1000 ml polyethylene beaker. A hand kitchen mixer obtained from Hamilton Beach under the trade designation “Portfolio” equipped with dual four bladed beaters each with a collar, was inserted into the beaker containing the optical elements and the coated sand. Each beater had a radius of 1.75 inches (4.4 cm), the width of each of the flour blades was ¼ inch (0.63 cm) and had a length of 3.25 inches (8.3 cm). The optical elements and the coated sand were mixed at maximum speed. The mixer and 1000 ml beaker were rotated so that the coated and clustered sand was drawn through the co-rotating beaters in the presence of the excess optical elements. This was continued until most or all of the coated sand was in the form of discrete particles, resulting in a sand core coated with a bonded resin core precursor and covered with optical elements. In order to solidify the bonded resin precursor coating, the coated sand particles having surfaces substantially covered with embedded optical elements were cured for 30 minutes in an 80° C. oven.

### Example 2

### Co-Rotating Blade Mixer Method

Retroeflective elements were prepared in a mixer vessel made by removing the bottom of a 1000 ml polyethylene beaker and attaching a three inch (7.6 cm) diameter polyethylene funnel with epoxy to obtain a vessel with a tapered bottom. A 0.5 inch (1.3 cm) ball valve was attached to the bottom of the funnel with tubing so that the flow of material out of the mixing vessel could be controlled. The vessel was suspended with a ring stand.

A bead hopper was made by removing the bottom from a two gallon Nalgene bottle. The bottomless bottle was suspended upside down with the ring stand and positioned directly above the mixer vessel. A 0.5 inch ball valve was also attached to the neck of the bottomless bottle with tubing so that the flow of material out of this hopper could be controlled. The Hamilton Beach hand kitchen mixer, were inserted in the mixer vessel.

Optical elements were poured into the suspended bead hopper. The ball valves on the bead hopper and mixer vessel were adjusted (opened) so that a constant level of optical elements in the vessel was maintained (1200 g). A screw conveyor consisting of a series of propeller blades was set up to coat the sand with binder composition and then feed the coated sand into the mixer vessel containing the optical elements and hand mixer. Bonded resin precursor was added to a pressure pot and air pressure was used to feed the binder into the screw conveyor. The feed rate of the sand and binder was adjusted to yield a 10:1 weight ratio respectively.

The bonded resin core precursor coated sand was then dropped into the mixer vessel where it was broken up into discrete particles by the hand mixer in the presence of excess optical elements. The result was a sand core coated with a binder and covered with optical elements. The retroreflective elements were carried out through the bottom of the beaker along with the excess optical elements and collected on a 500 micron sieve. The excess optical elements were returned to the bead hopper.

In order to solidify the bonded resin precursor coating, the coated sand particles having surfaces substantially covered with embedded optical elements were cured for 30 minutes in an 80° C. oven.

### Example 3

### Grinding Plate Method

Retroeflective elements were prepared using a mill obtained from Quaker City Mill Philadephia, Pa. under the trade designation “Model F NO 4”. The mill consisted of a five flight notched auger and 3.5 inch (8.9 cm) diameter model 4CS grinding plates. The hand crank was replaced with a 0.25 hp variable speed electric motor. The plates were gapped so that the sand would just pass through the plates without being ground. The speed of the variable speed electric motor was set to maximum that generated an auger and mill plate of 80 rpm. One part of the bonded resin core precursor was added to 10 parts of the sand. The sand and binder were mixed by hand with a spatula until all of the sand was thoroughly coated with binder. The coated sand was gradually added to the mill hopper and augered through the mill plates at a rate of 50 grams per minute. Optical elements were gravity fed into the exit end of the mill hopper just prior to the mill plates at a rate of 1000 grams per minute. The mill plates broke up the clustered binder coated sand in the presence of the excess optical elements, resulting in a sand core coated with a binder and covered with optical elements.

In order to solidify the bonded resin precursor coating, the coated sand particles having surfaces substantially covered with embedded optical elements were cured for 30 minutes in an 80° C. oven.

### Example 4

### Grinding Plate Method

Retroreflective elements were prepared using the procedure of Example 3 with the following exceptions. A tray was positioned under the mill with about a 30 degree slope. The bonded resin precursor coated sand only was fed through the mill plates at a rate of 50 grams per minute. The coated sand that exited the mill surprisingly was in the form of discrete particles. The discrete particles landed on the sloped tray and were immediately covered with an excess amount of optical elements that were poured over the particles in the tray. The result was a sand core coated with a binder and covered with optical elements.

In order to solidify the bonded resin precursor coating, the coated sand particles having surfaces substantially covered with embedded optical elements were cured for 30 minutes in an 80° C. oven.

### Example 5

### Extruder Method

A secondary (smaller) twin screw extruder, obtained from MAX Machinery, Healdsburg, Calif. under the trade designation “1.25 co-rotation sub assembly, part #745-400-095 was employed to mix a three component bonded resin polyurethane precursor composition. The first component was a pigmented polyol composition consisting of the following ingredients in parts per 100: 32.6 parts Tone 0301, 31.9 parts Afflair 9119, 12.5 parts methyl ethyl ketone, 12.5 parts acetone and 10.4 parts additives (dispersants, modifiers). The second component was Desmodur N-100. The third component was Afflair 9119. Two 2.5 gallon pressure pots, obtained from Binks, Glendale Heights, Ill. were used, one contained the pigmented polyol and the other contained Desmodur N-100. The compositions in each of the two pressure pots were metered into the twin-screw extruder via pumps, obtained from Zenith, Sanford, N.C. under the trade designation “BPB Series 0.297 cc/rev gear pump”. Component three was fed via a Model No. KCC-T20 K-TRON SODER powder feeder obtained from K-TRON, Pitman, N.J. and utilizing twin spiral pigtail screws into an open top port on the secondary extruder approximately two inches prior to the Component one and Component two feed streams. The three components were fed into the secondary extruder at a fixed weight percentage ratio of 47 wt-% of the first component to 31 wt-% of the second component to 22 wt-% of the third component.

The secondary extruder mixed and delivered the three components to the primary 50 mm co-rotating twin screw extruder (10L/D) obtained from Baker Perkins, Saginaw, Mich. under the trade designation “Baker Perkins MPCNV-50 Continuous Mixer”. The sand was surface treated with 600 ppm “Silquest A1100” (without “Krytox 157 FSL”) in the same manner as previously described for surface treating the beads. The sand was fed into the extruder via a single pigtail screw Model 105-D feeder obtained from ACRISON, Inc., Moonachi, N.J. The optical elements were fed into the extruder via a single pigtail screw feeder obtained from ACCURATE, Whitewater, Wis. The setup for the primary extruder was as follows in order from the beginning of the extruder to the exit of the extruder: (1) 5 inches (12.7 cm) of forward conveying flights, (2) 1.5 inches (3.8 cm) of reverse gear mixers 1050-3LDE-RFL/1.50-8, (3) 3 inches (7.6 cm) of forward conveying flights, (4) 3 inches (7.6 cm) of forward gear mixers 1050-3LDE-FFR/1.50-8, and (5) 8 inches (20.3 cm) of forward conveying flights. Feed locations of the binder, sand, and optical elements relative to the beginning of the extruder with their proximity to the screw assembly were: (1) sand addition at 3.5 (8.9 cm) inches with the bonded resin precursor through the same port at 4 inches (10.2 cm), (2) optical elements addition at 10 inches (25.4 cm) (over the forward gear mixer assembly) and (3) retroreflective elements exiting at 20 inches (50.8 cm).

In order to solidify the bonded resin precursor coating, the coated sand particles having surfaces substantially covered with embedded optical elements were cured for 30 minutes in an 80° C. oven. Other suitable operating conditions are set forth in Table I as follows:

TABLE I

| Bonder Resin | | | Screw | Retroreflective |
|---|---|---|---|---|
| Precursor | Core Particle | Bead Feed | Speed | Element Output |
| Feed Rate | Feed Rate | Rate | Rpm | Rate |
| 1.1 lbs./hr. | 10.8 lbs./hr. | 108 lbs./hr. | 20-90 | 20 lbs./hr. |
| 1.4 lbs./hr. | 13.5 lbs./hr. | 135 lbs./hr. | 20-90 | 25 lbs./hr. |
| 2.0 lbs./hr. | 20 lbs./hr. | 200 lbs./hr. | 20-200 | 37 lbs./hr. |
| 2.0 lbs./hr. | 20 lbs./hr. | 200 lbs./hr. | 77 | 37 lbs./hr. |
| 2.7 lbs./hr. | 27 lbs./hr. | 270 lbs./hr. | 20-200 | 50 lbs./hr. |
| 3.0 lbs./hr. | 29.7 lbs./hr. | 297 lbs./hr. | 40-200 | 55 lbs./hr. |
| 5.4 lbs./hr. | 54 lbs./hr | 541 lbs./hr. | 40-200 | 100 lbs./hr. |
| 8.1 lbs./hr. | 81 lbs./hr. | 811 lbs./hr. | 40-225 | 150 lbs./hr. |

### Example 6

### Rotating Disk Method

A disc coater was constructed generally as depicted in FIG. 1 of attorney docket no. FN59504US002 entitled “DISC COATER”, filed on the same day as the present application for patent, with the following particulars. The disc coater had a disc having an outside diameter of 22.9 cm (9 inches). The disc was constructed of metal and had adhered to its upper surface a layer of double-stick polyurethane foam adhesive tape 0.8 mm (1/32 inch) thick, commercially available from 3M Company, St. Paul, Minn. under the trade designation “Scotch Mounting Tape 110”. The restrictor was constructed of metal and had an outside diameter of 22.9 cm (9 inches) and an inside diameter of 10.2 cm (4 inches). The restrictor had a frusto-conical portion, sloping downward at a 20 degree angle from the horizontal from the inside diameter to the point where the diameter was 17.8 mm (7 inches). Peripheral to the frusto-conical portion of the restrictor was a flange portion projecting horizontally from the end of the frusto-conical portion the rest of the way to the outside diameter. The restrictor was mounted adjustably over the disc on a frame positioned by a fine pitch lead screw, and for the experiment described in this example, the flange portion was spaced so as to provide a gap of 1.3 mm (0.050 inch). The disc coater was further provided with a vibrating table dispenser, commercially available as Model 20 A from Eriez Magnetics of Erie, Pa., disposed above the disc inboard of the inside diameter of the restrictor.

The bonded resin core precursor was supplied through a pair of gear pumps commercially available as Zenith model BPB gear pump from Zenith Pumps Division of Parker Hannifin Corporation, Sanford, N.C.

The sand particles were dispensed by an AccuRate™ Tuf-Flex™ feeder, model 304, from Schenk Accurate, Whitewater, Wis., into a dynamic mixer of conventional design.

Into the same dynamic mixer was dispensed powdered the Afflair9119 using a separate AccuRate™ Tuf-Flex™ model 304 feeder.

The primary particles, the powdered pigment, and the bonded resin core precursor were dispensed into the dynamic mixer in a weight ratio of 47.62/1.06/3.70, and the dynamic mixer was operated at a speed of 100 rpm. The coated core particles of the dynamic mixer was directed onto the vibratory table of Example 1 at the rate of 0.4 kg/minute. The optical elements were provided by means of a K-Tron model KCL/T20 solids feeder, commercially available from K-Tron International, of Pittman, N.J., at a rate of 0.36 kg/min. The contents of the vibratory table were dispensed onto the disc with the disc rotating and the speed of 525 rpm, resulting in the formation of discrete retroreflective particles.

R_{A} Test Results

The brightness of the resulting retroreflective elements produced from each of the methods of Examples 1-6 was measured as previously described. A R_{A} value for each example averaged 25-35 candelas/lux/m².

1. A method of making retroreflective elements comprising:
providing a plurality of core particles;
coating the particles with an unsolidified polymeric composition forming coated particles;
combining the coated particles with optical elements in a continuous process such that optical elements are embedded in the unsolidified polymeric composition; and
solidifying the polymeric composition forming retroreflective elements.

2. The method of claim 1 wherein the combining of the coated particle and optical elements comprises mechanically mixing.

3. The method of claim 1 wherein the unsolidified polymeric composition is selected from a molten thermoplastic resin and a bonded resin core precursor composition

4. The method of claim 1 wherein an excess of optical elements are provided and the method further comprises separating the retroreflective elements from the unembedded optical elements.

5. The method of claim 1 wherein the core particles ranges in size from about 0.1 mm to about 3 mm.

6. The method of claim 1 wherein the core particles consist of an inorganic material.

7. The method of claim 6 wherein the particles consist of a material selected from sand, roofing granules, and skid particles.

8. The method of claim 1 wherein the mechanical mixing is accomplished by means of at least one rotating mixing member.

9. The method of claim 8 wherein the mixing member comprises a rotating disc.

10. The method of claim 8 wherein the mixing member comprises an extruder screw.

11. The method of claim 8 wherein the mixing member comprises a grinding plate.

12. The method of claim 8 wherein the mixing member comprises at least two co-rotating or counter-rotating mixing members.

13. The method of claim 1 further comprising combining the unsolidified polymeric composition with at least one light scattering material.

14. The method of claim 13 wherein the light scattering material is selected from the group comprising diffusely reflecting pigments, specularly reflecting pigment and combinations thereof.

15. The method of claim 1 wherein the optical elements consist of microcrystalline beads.

16. The method of claim 15 wherein the microcrystalline beads consist of glass-ceramic beads.

17. The method of claim 15 wherein the microcrystalline beads consist of non-vitreous beads.

18. The method of claim 1 wherein the optical elements are surface treated with at least one adhesion promoting agent.

19. The method of claim 1 wherein the optical elements are surface treated with at least one floatation agent.

20. The method of claim 19 wherein the floatation agent is a fluorochemical.

21. The method of claim 1 wherein the optical elements comprise first optical elements having a refractive index ranging from about 1.5 to about 2.0 and second optical elements have a refractive index ranging from about 1.7 to about 2.4.

22. A method of making retroreflective elements comprising:
providing a plurality of core particles having surfaces comprising an unsolidified polymeric composition;
combining the core particles with optical elements by means of a device comprising at least one rotating mixing member selected from the group consisting of a disc, an extruder screw, co-rotating blades, counter-rotating blades, and grinding plates, such that optical elements are embedded in the unsolidified polymeric composition; and
solidifying the polymeric composition forming retroreflective elements.

23. The method of claim 22 wherein the unsolidified polymeric composition is selected from a molten thermoplastic resin and a bonded resin core precursor composition

24. The method of claim 22 wherein further comprising coating an inorganic core particle with the unsoldified polymeric material.

25. An apparatus for the continuous manufacture of retroreflective elements comprising:
a means for providing a plurality core particles having surfaces comprising an unsolidified polymeric composition;
a means for providing optical elements;
a means for embedding the core particle with the optical elements forming retroreflective elements wherein the means comprises at least one rotating mixing member selected from the group consisting of a disc, an extruder screw, co-rotating blades, counter-rotating blades and a grinding plate; and
a means for solidifying the polymeric composition forming retroreflective elements.

26. A method of coating particles comprising:
providing a plurality of core particles;
coating the particles with an unsolidified polymeric composition forming coated particles;
combining the coated particles with second particles by means of a device comprising at least one rotating mixing member selected from the group consisting of a disc, an extruder a screw, co-rotating blades, counter-rotating blades, and a grinding plate, such that second particles are embedded in the unsolidified polymeric composition; and
solidifying the polymeric composition.

27. The method of claim 26 wherein the core particles have a maximum dimension and the second particle have a maximum dimension that is less than half the maximum dimension of the core particles.

28. The method of claim 26 wherein the unsolidified polymeric composition is a bonded resin core precursor composition

29. The method of claim 26 wherein the core particles comprises an inorganic material.

30. A method of making retroreflective elements comprising:
providing a plurality of core particles having surfaces comprising an unsolidified polymeric composition;
coating the particles with an unsolidified polymeric composition forming coated particles;
combining the coated particles with second particles by means of a device comprising at least one rotating mixing member selected from the group consisting of a disc, a screw, co-rotating blades, counter-rotating blades, and a grinding plate, such that second particles are embedded in the unsolidified polymeric composition; and
solidifying the polymeric composition.
